(19) United States
(12) Patent Application Publication
(10) Pub. No.: US 2010/0202291 A1
(43) Pub. Date: Aug. 12, 2010

(54) Method of Selecting Media Flow

(75) Inventors: Per Synnergren, Lulea (SE); Peter Hedman, Helsingborg (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/671,368

(22) PCT Filed: Jun. 10, 2008
(86) PCT No.: PCT/SE2008/050686

§ 371 Date: Jan. 29, 2010

(30) Foreign Application Priority Data
Jul. 30, 2007 (SE) 0701796-5

(51) Int. Cl. H04L 12/26

(52) U.S. Cl. 370/235

(57) ABSTRACT

In a method and a system for handling a request for a service or a media flow from a user of a cellular radio system, means are provided for deciding if an already existing PDP context or EPS Bearer is to be used for the requested service or media flow based on information received from the system.

### TECHNICAL FIELD

The present invention relates to a method and a device for selecting media flow in a cellular radio system.

### BACKGROUND

In existing cellular radio communication systems it is the responsibility of mobile stations to request suitable Packet Data Protocol (PDP) contexts for given services or media flows. Since it is the mobile stations that are in control of the negotiation of the PDP contexts, it is easy for any given mobile station to correlate which PDP contexts that are to be used for which services or media streams.

In 3GPP release 7 the concept of network requested Quality of Service (QoS) is introduced, see also 3GPP TS 23.060, General Packet Radio Service (GPRS); Service description; Stage 2. The basic idea is to allow the radio resource owner, the operators, to decide which bearer type to use for a given service or media flow.

The same principles would be used if the system is an EPS system, see 3GPP TS 23.401 and 23.402. E.g. if the 23.401 architecture is used then a PDN GW is used instead of a GGSN, MME instead of a SGSN and PDN connections or EPS bearers are used instead of PDP contexts and the procedure names are different.

The introduction of network requested PDP contexts results in that the decision point of which PDP context to use for a service or media flow is moved from the mobile station to the network. This means that the mobile station is not in control of the binding between PDP contexts and services/media flows, and as a result the mobile station cannot know what PDP context to use for a given service or media flow.

Therefore, the information of what type of PDP context to use for a given service/media flow must be notified by the network to the mobile station. Notifying what type of PDP context to use is a straightforward process in the case when there is no suitable PDP context already established. FIG. 1 shows the signaling flow for this case as it is already specified in 3GPP Release 7. Thus, when there is no suitable PDP context already established, the Gateway GPRS support Node (GGSN) first gets a trigger from the policy control structure that a new service or media flow is started. This leads to a policy decision that an additional PDP context using the “Activate secondary PDP context procedure” is to be established, with a certain quality of service (QoS) decided by the network policies.

Then the GGSN signals information about what type of PDP context to establish by sending an Initiate PDP Context Activation message with requested QoS, traffic flow template (TFT), protocol configuration options (PCO), etc. The information in step 2 is relayed to the mobile terminal by the SGSN using a Request PDP Context Activation message. The mobile terminal includes the information it received in step 3 in the “activate secondary PDP context procedure” to establish a new PDP context.

However, in the case of network requested PDP contexts, the network may want to use an already existing PDP context for the transfer of media. In that case the mobile station should not start the “activate secondary PDP context procedure” to establish a new PDP context. Instead the mobile terminal must be notified by the GPRS session management layer that the network has chosen an already existing PDP context for the transfer of media.

The reason that the mobile station must be notified that an already established PDP context is to be used for the transfer of media is shown in FIG. 2. The negotiation of an IP Multimedia subsystem (IMS) session contains two rounds of negotiation of media capabilities. The first round of negotiations is marked “1.” in FIG. 2. This round of negotiation will contain information of which media types IMS Client A wants to use in the communication as described in the SIP INVITE, and which of the offered media types IMS Client B supports as described in the SIP 183 Session Progress. Further the first round of negotiation will also contain information about the current resource reservation status for media for the two IMS clients. At this moment, IMS Client A and B does not know which PDP context to use for the media flow being negotiated, therefore, IMS Client A and IMS Client B will indicate that they have no resources for the media transfer using SDP attributes such as “a=inactive” and stating that the SIP preconditions are not met, i.e. stating that to the knowledge of the IMS Clients no resources are reserved.

In FIG. 2, the network initiates new PDP contexts for the media. This leads to signaling on the GPRS session management layer. The IMS Clients can access this information and will thus be notified that a new PDP context is set-up.

When the IMS Client A is notified that a new PDP context is set-up, i.e. resources are reserved for media, it initiates a second round of negotiation marked as “2.” in FIG. 2. The media configuration is the same as the result of the first round of negotiation. The difference is that the IMS Client A will now indicate that it has resources and can start media transfer by e.g. indication “a=sendrecv” and that the SIP preconditions are now met.

However, what is not solved is the case the network decides to use an already established PDP context for the media when the network requested PDP context activation procedure is used. In that case the IMS Clients, that do not know if any of the PDP contexts already established are suitable for the media transfer, indicate in the first round of negotiation that they do not have any resources (“a=inactive”, SIP preconditions not met).

Hence, there exist a need for a method, device and a system that is able to handle the case the network decides to use an already established PDP context for the media when the network requested PDP context activation procedure is used.

### SUMMARY

It is an object of the present invention to enable a cellular telecommunications system to use an already established PDP context for the media when the network requested PDP context activation procedure is used.

This object and others are obtained by the method, device and system as set out in the appended claims. Hence a method of selecting media flow in a cellular radio system is provided. In accordance with the method a request for a media flow from a mobile terminal can be received. When a request is received it can be determined that an existing PDP context or EPS bearer is to be used for the requested media flow, and it is signaled to the mobile station that an existing PDP context or EPS Bearer is to be used.

Because there in conventional systems is no signal to send from the network to the IMS Client to notify that the network has decided that the IMS Client should use an already established PDP context for media transfer, it is not possible to use an established PDP context for media transfer. Hence, in existing systems the IMS Clients will never be notified that resources are actually already present and they cannot proceed with the IMS session set-up signaling sequence and signal that they have resources.

In accordance with the present invention a signal is used to indicate for the mobile terminal/IMS Client that an already established PDP context is the preferred choice of the network to be used for the media transfer. For example the already existing “GGSN-Initiated PDP Context Modification Procedure” or the “Network Requested PDP Context Activation” procedure may be used or an equivalent signal can be added to indicate for the mobile terminal/IMS Client that an already established PDP context is the preferred choice of the network to be used for the media transfer. This can be obtained by sending information to the mobile station including one or more identifiers that the mobile station can use to correlate with an already existing PDP context. Such identifiers may for example be:
Traffic flow template (TFT) with uplink and/or downlink filter information
Network Service Access Point Identifier (NSAPI)
PDP address

### BRIEF DESCRIPTION OF THE DRAWINGS

The present invention will now be described in more detail by way of non-limiting examples and with reference to the accompanying drawings, in which:

FIG. 1 is a view illustrating a set-up of a network requested PDP context,

FIG. 2 is a view illustrating IMS session set-up signaling, and

FIG. 3 is a view illustrating a session set-up using pre-established/already existing PDP context,

FIG. 4 is a node in a cellular radio system,

FIG. 5 is a mobile station, and

FIG. 6 is a flowchart illustrating procedural steps performed in a cellular radio system.

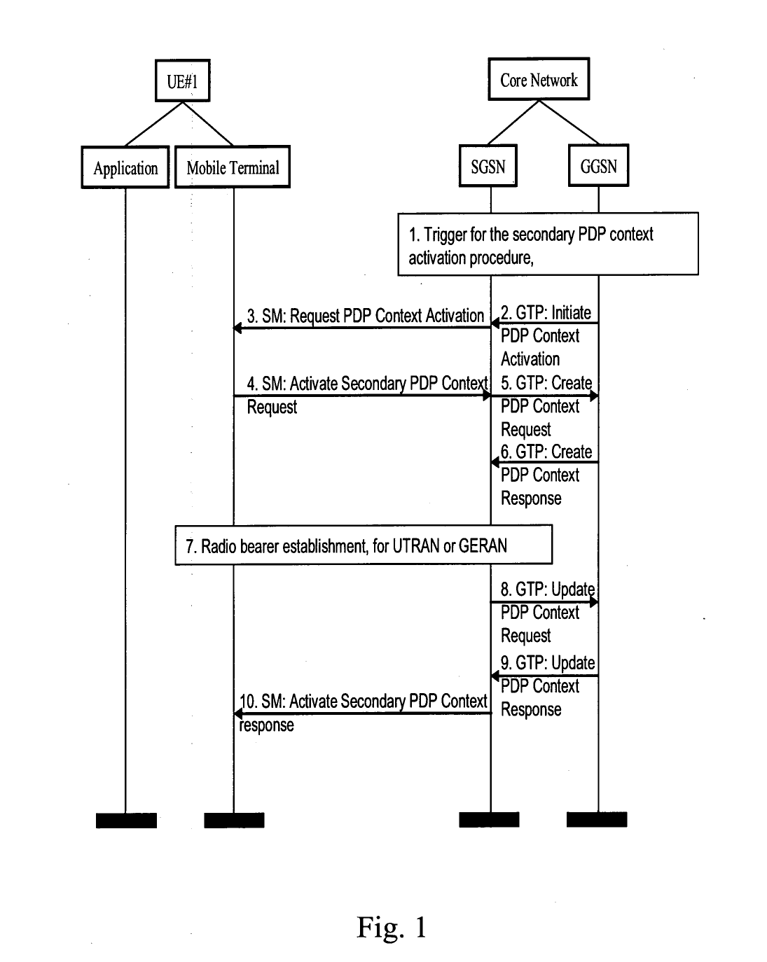

### DETAILED DESCRIPTION

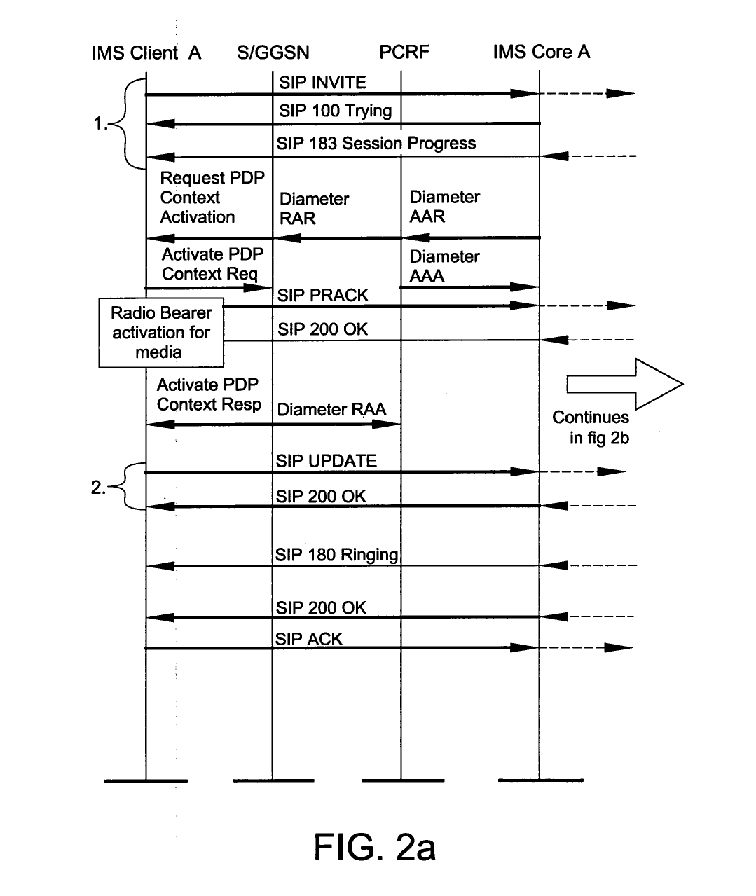

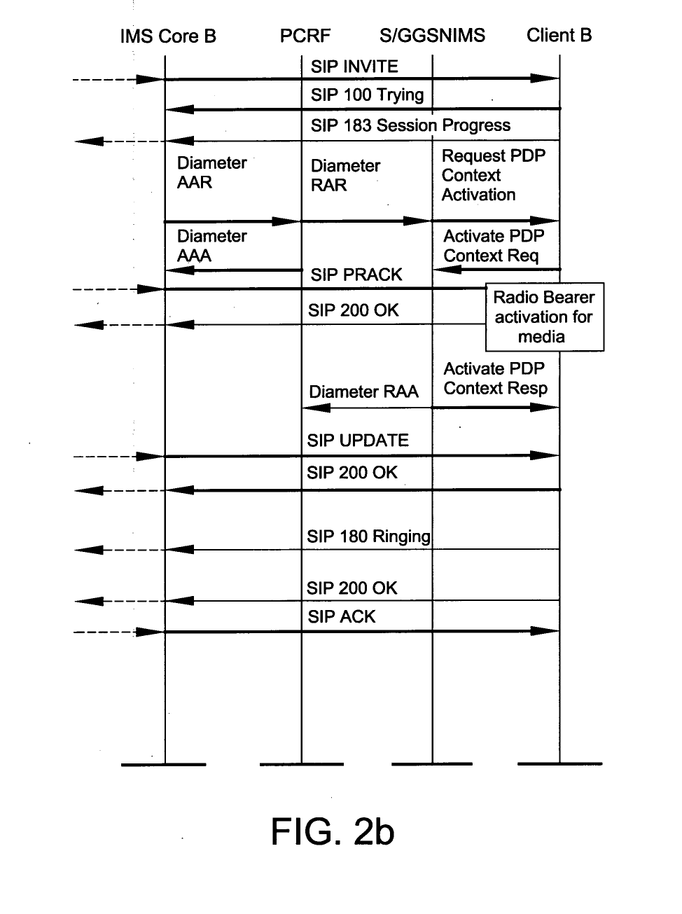

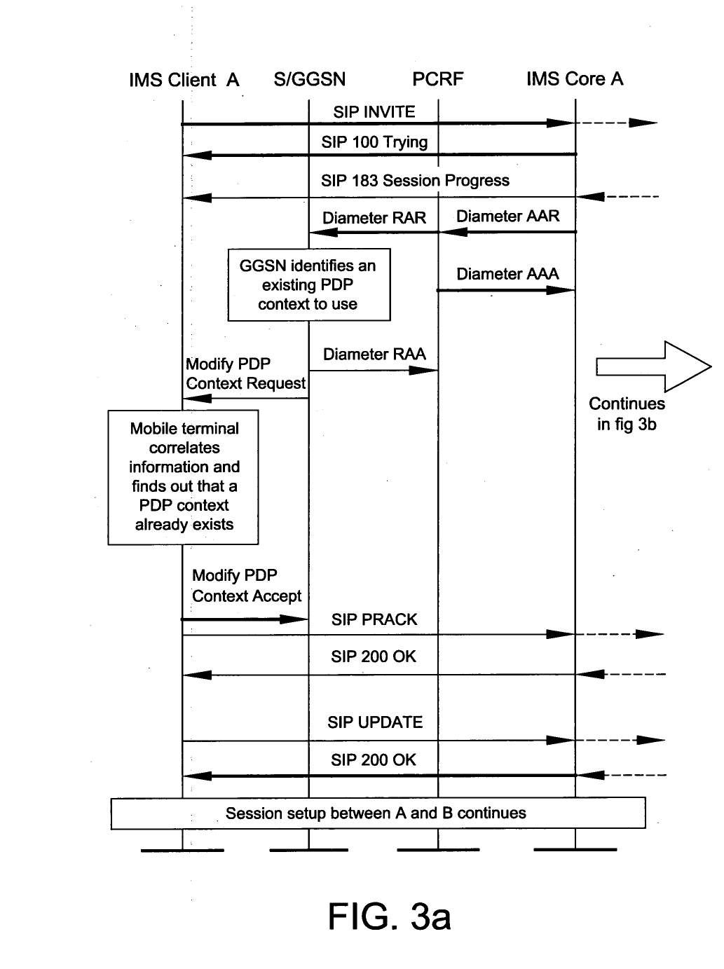

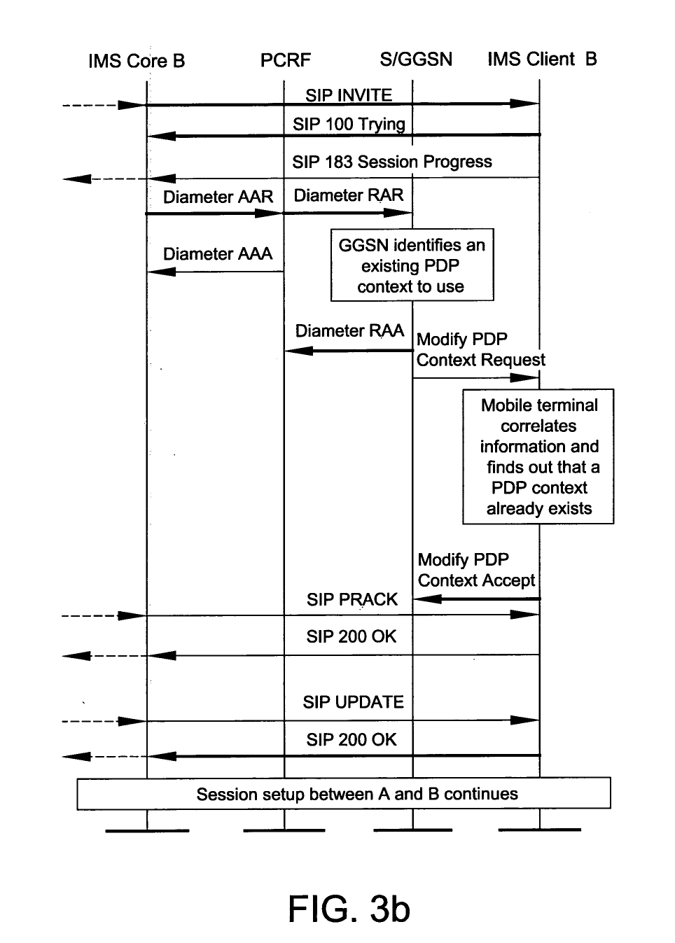

In case the network has decided to use a PDP context that is already set-up, the signaling flow in FIG. 2 can be as depicted in FIG. 3. Thus, the IMS core A sends a Diameter AAR to give service/media flow information to the PCRF. The PCRF makes a policy decision and sends down the information in a Diameter RAR message. The GGSN, which is the policy enforcement point, enforces the policies and as a result it is decided that an already existing PDP context is to be used for this service/media flow.

In accordance with one embodiment the GGSN can then directly acknowledge the Diameter RAR with a Diameter RAA to the PCRF and at the same time sends information to the mobile station via the SGSN using either:
The Update PDP Context Request message if using the GGSN initiated PDP context modification procedure for this purpose (not shown in FIG. 3), or
Another suitable message, for example. Initiate PDP Context Activation using the Network Requested Secondary PDP Context Activation procedure for this purpose
   which is sent to the SGSN.

This message can be said to carry information to SGSN that an already existing PDP context is to be used for the service or media transfer. In case that an Update PDP Context Request message is used, the SGSN will regard the procedure as a normal GGSN initiated PDP context modification and not be aware that the system maps a new media flow on an already existing PDP context when using network requested QoS. However, if another signal (e.g. the Initiate PDP Context Activation) is to be used, new SGSN logic may or may not be needed to understand that an already initiated PDP context is to be used. Information provided to SGSN to be used to identify the PDP context may for example be:
a GTP Tunnel identifier (e.g. TEID)
a NSAPI (identifier of the PDP context)
a PDP address, or
Traffic flow template (TFT) filters

The SGSN is then enabled use this information and correlate it with its already established PDP contexts and understand that it already has this PDP context activated, if needed. Regardless if new SGSN logic is used or the already existing GGSN initiated PDP context modification or Network Requested PDP Context Activation logic is used, the SGSN has to notify the mobile station, which is configured to use network requested PDP context activation that the service/media flow will be sent over an already existing PDP context.

This information can be sent to the mobile terminal using for example:
a Modify PDP Context Request message, or
another suitable message, such as the Request PDP Context Activation message

In order too inform the mobile terminal that an already existing PDP context is to be used for the service or media transfer. The information provided to the mobile station to inform about this may for example be one or more of
a NSAPI (identifier of the PDP context)
a PDP address
a Traffic flow template (TFT) with uplink and/or downlink filter information

Moreover, it is probable that the uplink TFT is to be used. The TFT will force the mobile station to route the media stream over the appropriate PDP Context/RAB. The TFT information, e.g. uplink and downlink filter information or DSCP, together with the PDP address and APN is enough for the UE to understand to which Service Data Flow the PDP context is to be used for. For IMS this means that the IP address and ports announced in the SDP corresponds to the TFT information received. For another service, or if SDP is updated with DSCP, Diffserv Codepoints (DSCP) may be used to correlate the service with the appropriate PDP context.

If the PDP context to be used does not already include TFT (zero or one PDP context may lack TFT information), then the network directs the media stream to the PDP context by adding TFT to the PDP context by using the GGSN initiated PDP context modification procedure.

The mobile station then correlates or configures itself to use the information received by the network, which leads to the use of an already established PDP context. This results in that a PDP context which already exists is used and there is no need to start a secondary PDP context activation procedure.

After the mobile terminal has found out that the service/media flow will use an already existing PDP context, it informs the IMS Client that it has resources. Thereafter the IMS Client proceeds with the IMS session set-up signaling, indicating that it has resources for the media.

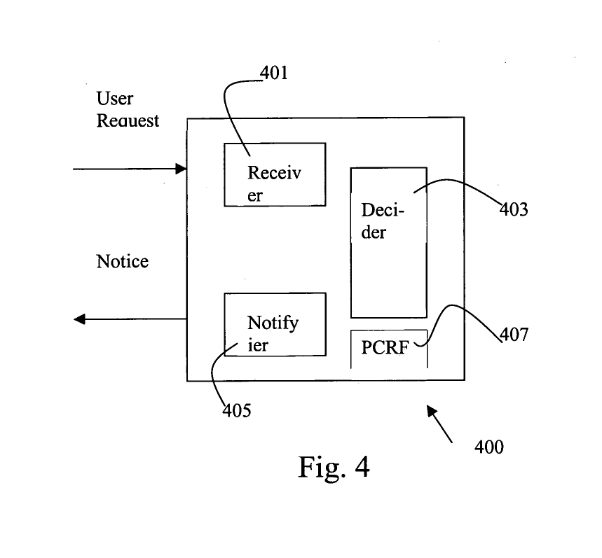

In FIG. 4 a node 400 of a cellular radio system is depicted. The node 400 comprises a policy control function (PCRF) 407 adapted to make policy decisions relating to which PDP context to use for a particular request for a service or a media flow from a mobile station connected to the cellular radio system. The PCRF may also be located outside the node 400 in which case the node 400 is adapted to connect to the PCRF. The node 400 further comprises a receiver adapted to receive requests for different services or a media flows from mobile stations connected to the cellular radio system. The node 400 also comprises a decider unit 403 that is adapted to decide that an already existing PDP context is to be used for a received request for a service or a media flow from a mobile station in case there is a suitable existing PDP context to use. Also the node 400 comprises a module for signaling to another network node, such as a Serving GPRS Support Node (SGSN) that, that an already existing PDP context is to be used for a requested service or media flow by sending information about the PDP context to be used.

The information about the already existing PDP context can for example be—a GTP Tunnel identifier (e.g. TEID), a NSAPI (identifier of the PDP context), a PDP address, or Traffic flow template (TFT) filters.

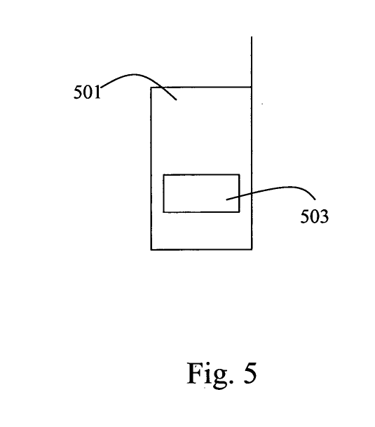

In FIG. 5 a mobile station 501 is depicted. The mobile station comprises a unit 503 adapted to configure configures itself by using received PDP context information for finding out that it already has this PDP context activated as described above.

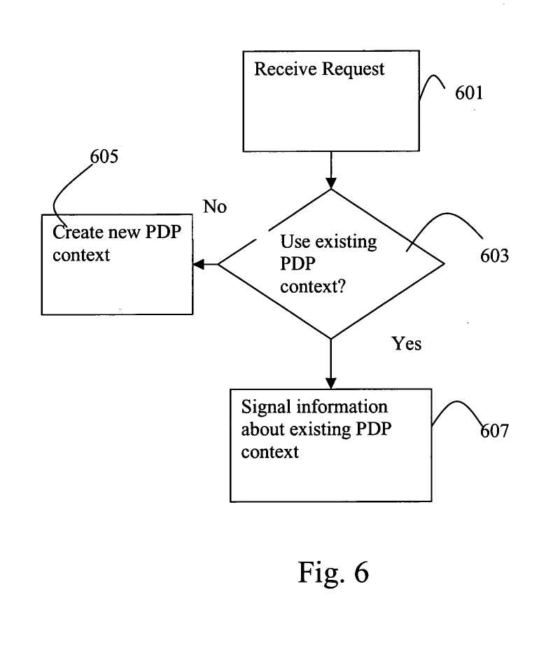

In FIG. 6 a flow chart illustrating procedural steps performed when deciding PDP context for a requested media flow in a cellular radio system is depicted. First in a step 601 a request for a media flow (or a service) is received from a mobile terminal. Next in a step 603 it is decided if an existing PDP context is to be used for the requested media flow. If in step 603 it is decided that an existing PDP context is to be used the procedure continues to a step 605. If in step 603 it is decided that a new PDP context is to be used, the procedure continues to a step 607 where a new PDP context is created in accordance with existing principles.

In step 605 a notification is sent towards the requesting mobile terminal, for example via an SGSN, comprising information about the PDP context to be used.

Using the method, device and system as described herein will result in that a cellular telecommunications network can route traffic over already existing PDP contexts or EPS Bearer when using network requested PDP context or EPS Bearer activation.

1-7. (canceled)

8. A cellular radio system comprising a node comprising:
a policy control function (PCRF), or said node being configured to access a PCRF;
a receiver configured to receive a request for a service or a media flow from a user of the cellular radio system; and
a logic circuit configured to decide between an already existing Packet Data Protocol (PDP) context or Evolved Packet System (EPS) Bearer to be used for the requested service or a media flow based on information received from the PCRF in case network requested PDP context activation is configured to be used.

9. The node of claim 8, wherein the node is further configured to notify another network node, in particular a Serving GPRS Support Node (SGSN) that an already existing PDP context or EPS Bearer is to be used for the requested service or media flow by sending information about the PDP context or EPS Bearer to be used.

10. The node of claim 9, wherein the PDP context information is any of a Tunnel Endpoint Identifier (TEID), a Network Service Access Point Identifier (NSAPI), a PDP/PDN address, a Traffic flow template (TFT), or access point name (APN), enabling correlation of the received information with information about already existing PDP contexts or EPS Bearers for finding out if the notification is about an already existing PDP context or EPS Bearer.

11. A mobile station comprising a self-configuring unit adapted to configure the mobile station by using received PDP context or EPS Bearer information for finding out that the mobile station already has the PDP context or EPS Bearer activated.

12. The mobile station of claim 11, wherein the self-configuring unit is adapted to use at least one of TFT information, DSCP, PDP/PDN address and APN, to determine to which Service Data Flow the PDP context or EPS Bearer is associated with.

13. A method of selecting media flow in a cellular radio system, comprising:
receiving a request for a media flow from a mobile terminal;
determining that an existing PDP context or EPS bearer is to be used for the requested media flow; and
signaling that the existing PDP context or EPS Bearer is to be used to the mobile terminal.

14. The method according to claim 13, wherein the PDP context or EPS Bearer information is any of a TEID, a NSAPI, a PDP/PDN address, a TFT, or an access point name (APN), enabling correlation of the received information with information about already existing PDP contexts or EPS Bearers for finding out if the notification is about an already existing PDP context or EPS Bearer.
